(19) United States
(12) Patent Application Publication
(10) Pub. No.: US 2025/0232920 A1
(43) Pub. Date: Jul. 17, 2025

(54) MULTILAYER CERAMIC CAPACITOR

(71) Applicant: Murata Manufacturing Co., Ltd., Nagaokakyo-shi (JP)

(72) Inventors: Yukihiro FUJITA, Nagaokakyo-shi (JP); Ryutaro YAMATO, Nagaokakyo-shi (JP)

(21) Appl. No.: 19/171,466

(22) Filed: Apr. 7, 2025

Related U.S. Application Data
(63) Continuation of application No. PCT/JP2023/045609, filed on Dec. 20, 2023.

(30) Foreign Application Priority Data
Dec. 28, 2022 (JP) 2022-211264

(51) Int. Cl. H01G 4/232; H01G 4/008; H01G 4/12; H01G 4/236; H01G 4/30; H01G 13/00

(52) U.S. Cl. CPC H01G 4/232; H01G 4/008; H01G 4/1227; H01G 4/1236; H01G 4/236; H01G 4/30; H01G 13/006

(57) ABSTRACT

A multilayer ceramic capacitor includes a capacitor body including dielectric layers, and first and second inner electrodes, a first via conductor inside the capacitor body and electrically connected to the first inner electrodes, a second via conductor inside the capacitor body and electrically connected to the second inner electrodes, a first outer electrode on at least one of a first and second main surface of the capacitor body facing each other in a lamination direction and connected to the first via conductor, a second outer electrode on the at least one of the first and second main surfaces of the capacitor body and connected to the second via conductor, and a first metal layer on a side surface of the capacitor body and electrically connected to the first via conductor.

### CROSS REFERENCE TO RELATED APPLICATIONS

This application claims the benefit of priority to Japanese Patent Application No. 2022-211264 filed on Dec. 28, 2022 and is a Continuation application of PCT Application No. PCT/JP2023/045609 filed on Dec. 20, 2023. The entire contents of each application are hereby incorporated herein by reference.

### BACKGROUND OF THE INVENTION

### 1. Field of the Invention

The present invention relates to multilayer ceramic capacitors.

### 2. Description of the Related Art

Multilayer capacitors are known that have an equivalent series inductance (ESL) reduced by widening or shortening a route through which a current flows, or canceling out magnetic fields generated by currents of different polarities, for example. Japanese Unexamined Patent Application Publication No. 2006-135333 discloses an example of a multilayer capacitor with a reduced ESL.

The multilayer capacitor disclosed in Japanese Unexamined Patent Application Publication No. 2006-135333 includes a capacitor body in which a plurality of dielectric layers, a plurality of first inner electrodes, and a plurality of second inner electrodes are laminated. The capacitor body is provided with a plurality of first via conductors that are electrically connected to the plurality of first inner electrodes and extend to one main surface of the capacitor body, and a plurality of second via conductors that are electrically connected to the plurality of second inner electrodes and extend to the one main surface of the capacitor body. On the one main surface of the capacitor body, a plurality of first outer electrodes electrically connected to the plurality of first via conductors, respectively, and a plurality of second outer electrodes electrically connected to the plurality of second via conductors, respectively, are provided.

In order to manufacture the multilayer capacitor described in Japanese Unexamined Patent Application Publication No. 2006-135333 above, it is conceivable to use a method of forming the first outer electrodes and the second outer electrodes by plating using a rotary plating method. In a barrel plating method as an example of the rotary plating method, for example, a number of capacitor bodies and a number of conductive media are placed in a rotatable barrel, and the barrel is rotated in a plating solution, thus applying an electric current to form plating in a plating formation region where the first via conductor and the second via conductor are exposed on the surface of the capacitor body. The conductive media are each a spherical body made of metal, for example. The rotary plating method makes it possible to form a large number of multilayer capacitors at the same time by forming the first outer electrodes and the second outer electrodes on the surfaces of a large number of capacitor bodies in a single plating process.

However, since the region of the surface of the capacitor body where the first and second via conductors are exposed is small, there is a possibility that the conductive media do not come into contact with the plating formation region during plating, resulting in no plated film being formed or a multilayer capacitor being manufactured with the plated film not sufficiently formed.

### SUMMARY OF THE INVENTION

Example embodiments of the present invention provide multilayer ceramic capacitors each enabling more reliable formation of outer electrodes by a rotary plating method.

A multilayer ceramic capacitor according to an example embodiment of the present invention includes a capacitor body including a plurality of dielectric layers, a plurality of first inner electrodes, and a plurality of second inner electrodes that are laminated, a first via conductor inside the capacitor body and electrically connected to the plurality of first inner electrodes, a second via conductor inside the capacitor body and electrically connected to the plurality of second inner electrodes, a first outer electrode on at least one of a first main surface and a second main surface facing each other in a lamination direction of the plurality of dielectric layers, the plurality of first inner electrodes, and the plurality of second inner electrodes, and connected to the first via conductor, a second outer electrode on the at least one of the first main surface and second main surface of the capacitor body and connected to the second via conductor, and a first metal layer on a side surface of the capacitor body other than the first main surface and the second main surface, and electrically connected to the first via conductor.

A multilayer ceramic capacitor according to another example embodiment of the present invention includes a capacitor body including a plurality of dielectric layers, a plurality of first inner electrodes, and a plurality of second inner electrodes that are laminated, a first via conductor inside the capacitor body and electrically connected to the plurality of first inner electrodes, a second via conductor inside the capacitor body and electrically connected to the plurality of second inner electrodes, a first outer electrode on at least one of a first main surface and a second main surface facing each other in a lamination direction of the plurality of dielectric layers, the plurality of first inner electrodes, and the plurality of second inner electrodes, and connected to the first via conductor, a second outer electrode on the at least one of the first main surface and the second main surface of the capacitor body and connected to the second via conductor, a first metal layer on a side surface of the capacitor body other than the first main surface and the second main surface, and electrically connected to the first via conductor, and a second metal layer on the side surface of the capacitor body and electrically connected to the second via conductor.

In multilayer ceramic capacitors according to example embodiments of the present invention, a first metal layer electrically connected to a first via conductor is provided on a side surface of a capacitor body. This enables more reliable formation of outer electrodes by rotary plating. Specifically, during rotary plating, plating can be performed in a plating formation region not only when a conductive medium comes into contact with the plating formation region where the first via conductor is exposed, but also when the conductive medium comes into contact with the first metal layer. This enables more reliable formation of the first outer electrodes.

In multilayer ceramic capacitors according to example embodiments of the present invention, a first metal layer electrically connected to a first via conductor and a second metal layer electrically connected to a second via conductor are provided on a side surface of a capacitor body. This enables more reliable formation of the outer electrodes by rotary plating. Specifically, during rotary plating, plating can be performed in a plating formation region not only when a conductive medium comes into contact with the plating formation region where the first via conductor and the second via conductor are exposed, but also when the conductive medium comes into contact with the first metal layer and the second metal layer. This enables more reliable formation of the first outer electrodes and the second outer electrodes.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1A is a top view schematically illustrating a multilayer ceramic capacitor according to a first example embodiment of the present invention, and FIG. 1B is a bottom view schematically illustrating the multilayer ceramic capacitor according to the first example embodiment of the present invention.

FIG. 2 is a side view of the multilayer ceramic capacitor illustrated in FIGS. 1A and 1B are viewed in a direction of arrow Y1.

FIG. 3 is a cross-sectional view taken along line III-III in FIGS. 1A and 1B, schematically illustrating a structure of the multilayer ceramic capacitor illustrated in FIGS. 1A and 1B.

FIG. 4A is a plan view schematically illustrating a first inner electrode, and FIG. 4B is a plan view schematically illustrating a second inner electrode.

FIGS. 5A to 5D are partially enlarged views schematically illustrating various examples of the positional relationship between a second metal layer and a second connection layer, and FIGS. 5E to 5H are partially enlarged views schematically illustrating examples of the shape of the second connection layer corresponding to FIGS. 5A to 5D, respectively.

FIG. 6 is a side view schematically illustrating the multilayer ceramic capacitor according to the first example embodiment of the present invention mounted on a mounting substrate.

FIG. 7A is a plan view schematically illustrating a first inner electrode when a first connection layer and a second connection layer are provided in one layer, and FIG. 7B is a plan view schematically illustrating a second inner electrode when the first connection layer and the second connection layer are provided in one layer.

FIG. 8A is a plan view schematically illustrating a first inner electrode and a first connection layer when a first connection layer is provided in a layer in which the first inner electrode is provided but a second connection layer is not provided, and FIG. 8B is a plan view schematically illustrating a second inner electrode and a second connection layer when a second connection layer is provided in a layer in which the second inner electrode is provided but a first connection layer is not provided.

FIG. 9 is a flowchart for explaining an example of a method for manufacturing a multilayer ceramic capacitor.

FIG. 10A is a top view schematically illustrating a multilayer ceramic capacitor according to a second example embodiment of the present invention, and FIG. 10B is a bottom view schematically illustrating the multilayer ceramic capacitor according to the second example embodiment of the present invention.

FIG. 11 is a side view of the multilayer ceramic capacitor illustrated in FIGS. 10A and 10B as viewed in a direction of arrow Y2.

FIG. 12A is a plan view schematically illustrating a first inner electrode in the multilayer ceramic capacitor according to the second example embodiment of the present invention, and FIG. 12B is a plan view schematically illustrating a second inner electrode.

FIG. 13A is a top view schematically illustrating a multilayer ceramic capacitor according to a third example embodiment of the present invention, and FIG. 13B is a bottom view schematically illustrating the multilayer ceramic capacitor according to the third example embodiment of the present invention.

FIG. 14A is a plan view schematically illustrating a first inner electrode in the multilayer ceramic capacitor according to the third example embodiment of the present invention, and FIG. 14B is a plan view schematically illustrating a second inner electrode.

FIG. 15A is a top view schematically illustrating a multilayer ceramic capacitor according to a fourth example embodiment of the present invention, and FIG. 15B is a bottom view schematically illustrating the multilayer ceramic capacitor according to the fourth example embodiment of the present invention.

FIG. 16 is a side view of the multilayer ceramic capacitor illustrated in FIGS. 15A and 15B as viewed in a direction of arrow Y3.

FIG. 17A is a plan view schematically illustrating a first inner electrode in the multilayer ceramic capacitor according to the fourth example embodiment of the present invention, and FIG. 17B is a plan view schematically illustrating a second inner electrode.

FIGS. 18A and 18B are plan views illustrating a modification of the multilayer ceramic capacitor according to the fourth example embodiment of the present invention, FIG. 18A schematically illustrating a first inner electrode and a first connection layer when the first connection layer is provided in a layer in which the first inner electrode is provided but a second connection layer is not provided, and FIG. 18B schematically illustrating a second inner electrode and a second connection layer when the second connection layer is provided in a layer in which the second inner electrode is provided but a first connection layer is not provided.

FIG. 19 is a top view of a multilayer ceramic capacitor, schematically illustrating another arrangement pattern of outer electrodes when an odd number of outer electrodes are provided in the row direction and an odd number of outer electrodes are provided in the column direction.

FIGS. 20A and 20B are top views of a multilayer ceramic capacitor, each schematically illustrating another arrangement pattern of outer electrodes when an even number of outer electrodes are provided in the row direction and an odd number of outer electrodes are provided in the column direction.

FIGS. 21A and 21B are top views of a multilayer ceramic capacitor, each schematically illustrating another arrangement pattern of outer electrodes when an even number of outer electrodes are provided in the row direction and an even number of outer electrodes are provided in the column direction.

### DETAILED DESCRIPTION OF THE EXAMPLE EMBODIMENTS

Hereinafter, features of the present invention will be specifically described with reference to example embodiments of the present invention and the drawings.

### First Example Embodiment

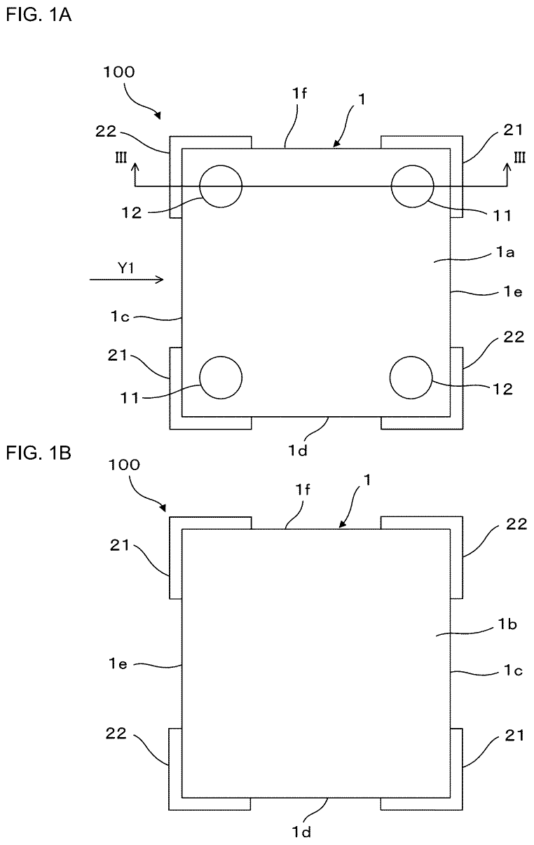

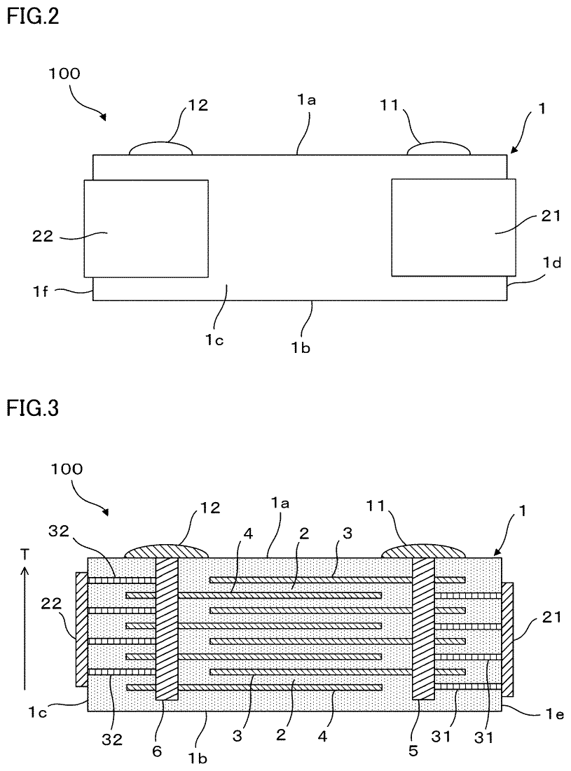

FIG. 1A is a top view schematically illustrating a multilayer ceramic capacitor 100 according to a first example embodiment of the present invention. FIG. 1B is a bottom view schematically illustrating the multilayer ceramic capacitor 100 according to the first example embodiment. Here, a first main surface 1a of a capacitor body 1 to be described later will be referred to as a top surface, and a second main surface 1b will be referred to as a bottom surface. FIG. 2 is a side view of the multilayer ceramic capacitor 100 illustrated in FIGS. 1A and 1B as viewed in a direction of arrow Y1. FIG. 3 is a cross-sectional view taken along line III-III in FIGS. 1A and 1B, schematically illustrating a structure of the multilayer ceramic capacitor 100 illustrated in FIGS. 1A and 1B.

The multilayer ceramic capacitor 100 includes the capacitor body 1, a first via conductor 5, a second via conductor 6, a first outer electrode 11, a second outer electrode 12, and a first metal layer 21. The multilayer ceramic capacitor 100 according to the present example embodiment further includes a second metal layer 22. The multilayer ceramic capacitor 100 according to the present example embodiment further includes a first connection layer 31 and a second connection layer 32.

As illustrated in FIG. 3, the capacitor body 1 has a structure in which a plurality of dielectric layers 2, a plurality of first inner electrodes 3, and a plurality of second inner electrodes 4 are laminated. More specifically, the capacitor body 1 has a structure in which the first inner electrodes 3 and the second inner electrodes 4 are alternately laminated with the dielectric layers 2 interposed therebetween.

The dielectric layer 2 can be made of any material, for example, a ceramic material whose main component is BaTiO₃, CaTiO₃, SrTiO₃, SrZrO₃, CaZrO₃, or the like. A subcomponent such as, for example, a Mn compound, a Fe compound, a Cr compound, a Co compound, or a Ni compound may be added to these main components in amounts less than the main components.

The capacitor body 1 may have any shape. In the present example embodiment, the capacitor body 1 has a rectangular or substantially rectangular parallelepiped shape as a whole. The rectangular parallelepiped shape as a whole is not a perfect rectangular parallelepiped shape, such as a shape in which the corners and edges of the rectangular parallelepiped are rounded, or a shape in which the surface of the rectangular parallelepiped has irregularities. The rectangular parallelepiped shape as a whole is a shape that includes six surfaces and can be considered as a rectangular parallelepiped as a whole. The capacitor body 1 therefore includes the first main surface 1a, the second main surface 1b, a first side surface 1c, a second side surface 1d, a third side surface 1e, and a fourth side surface 1f.

The first main surface 1a and the second main surface 1b of the capacitor body 1 are surfaces facing each other in a lamination direction T of the dielectric layer 2, the first inner electrode 3, and the second inner electrode 4. The first side surface 1c to the fourth side surface 1f of the capacitor body 1 define four side surfaces, other than the first main surface 1a and the second main surface 1b, among the surfaces of the capacitor body 1. The first side surface 1c faces the third side surface 1e, and the second side surface 1d faces the fourth side surface 1f. The first side surface 1c to the fourth side surface 1f of the capacitor body 1 are orthogonal or substantially orthogonal to the first main surface 1a and the second main surface 1b, respectively, in the present example embodiment, but do not have to be orthogonal or substantially orthogonal thereto.

The capacitor body 1 may have any dimensions. For example, the vertical dimension of the rectangular or substantially rectangular capacitor body 1 in plan view in the lamination direction T can be about 0.3 mm to about 3.0 mm, the horizontal dimension can be about 0.3 mm to about 3.0 mm, and the dimension in the lamination direction T can be about 50 μm to about 200 μm. The dimension of the capacitor body 1 in the lamination direction T refers to the thickness of the capacitor body 1.

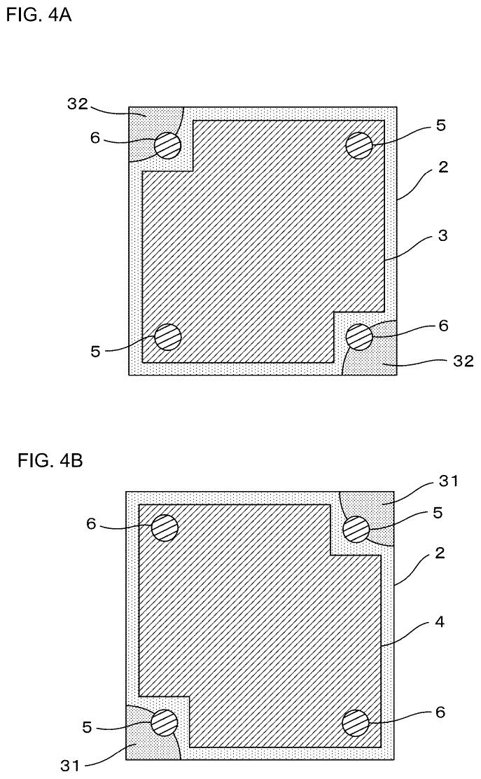

FIG. 4A is a plan view schematically illustrating the first inner electrode 3. FIG. 4B is a plan view schematically illustrating the second inner electrode 4. FIGS. 4A and 4B also illustrate the dielectric layer 2, the first via conductor 5, and the second via conductor 6. FIG. 4A also illustrates the second connection layer 32 to be described later. FIG. 4B also illustrates the first connection layer 31 to be described later.

As illustrated in FIGS. 4A and 4B, the shape of the dielectric layer 2 when viewed in the lamination direction T is rectangular or substantially rectangular in the present example embodiment. The shape of the first inner electrode 3 when viewed in the lamination direction T is not rectangular. Specifically, as illustrated in FIG. 4A, the first inner electrode 3 has a shape obtained by removing a pair of corners from a rectangle. The shape of the removed corners is rectangular or substantially rectangular, for example. Similarly, the shape of the second inner electrode 4 when viewed in the lamination direction T is not rectangular. Specifically, as illustrated in FIG. 4B, the second inner electrode 4 has a shape obtained by removing a pair of corners from a rectangle. The shape of the removed corners is rectangular or substantially rectangular, for example. However, the shape of the first inner electrode 3 is not limited to the shape illustrated in FIG. 4A, and the shape of the second inner electrode 4 is not limited to the shape illustrated in FIG. 4B.

The first inner electrode 3 and the second inner electrode 4 can be made of any material, for example, metals such as Ni, Cu, Ag, Pd, Pt, Fe, Ti, Cr, Sn or Au, or alloys including these metals. The first inner electrode 3 and the second inner electrode 4 may include the same ceramic material as dielectric ceramic included in the dielectric layer 2, as a common material. In such a case, the ratio of the common material included in the first inner electrode 3 and the second inner electrode 4 is, for example, less than or equal to about 20 vol %.

The first inner electrode 3 and the second inner electrode 4 may have any thickness of, for example, about 0.3 μm to about 1.0 μm. The first inner electrode 3 and the second inner electrode 4 may have any number of layers. The total number of layers of the first inner electrode 3 and the second inner electrode 4 can be, for example, 10 to 150.

In the multilayer ceramic capacitor 100, an electrostatic capacitance is generated by the first inner electrode 3 and the second inner electrode 4 facing each other with the dielectric layer 2 interposed therebetween.

The first via conductor 5 and the second via conductor 6 are provided inside the capacitor body 1. In the present example embodiment, as illustrated in FIGS. 1A and 1B, a plurality of first via conductors 5 and a plurality of second via conductors 6 are provided in a matrix. More specifically, four via conductors including two first via conductors 5 and two second via conductors 6 are provided at positions corresponding to the four corners of the rectangular or substantially rectangular capacitor body 1 in plan view in the lamination direction T. However, the arrangement of the first via conductors 5 and the second via conductors 6 is not limited to such a matrix arrangement. Furthermore, the number of the first via conductors 5 and the number of the second via conductors 6 are not limited to two, and can be any number.

As illustrated in FIG. 3, the first via conductor 5 is provided inside the capacitor body 1 so as to extend in the lamination direction T from the first main surface 1a toward the second main surface 1b of the capacitor body 1, and is electrically connected to the plurality of first inner electrodes 3. The first via conductor 5 is spaced apart from the second inner electrode 4 and is insulated from the second inner electrode 4.

As illustrated in FIG. 3, the second via conductor 6 is provided inside the capacitor body 1 so as to extend in the lamination direction T from the first main surface 1a toward the second main surface 1b of the capacitor body 1, and is electrically connected to the plurality of second inner electrodes 4. The second via conductor 6 is spaced apart from the first inner electrode 3 and is insulated from the first inner electrode 3.

As illustrated in FIG. 3, the first via conductor 5 and the second via conductor 6 are not exposed to the second main surface 1b of the capacitor body 1, but may be exposed.

The material of the first via conductor 5 and the second via conductor 6 can be made of any material, for example, metals such as Ni, Cu, Ag, Pd, Pt, Fe, Ti, Cr, Sn or Au, or alloys including these metals.

The first via conductor 5 and the second via conductor 6 may have any shape, for example, a cylindrical shape. In that case, the first via conductor 5 and the second via conductor 6 have a diameter of, for example, about 30 μm to about 150 μm.

The first outer electrode 11 is provided on at least one of the first main surface 1a and the second main surface 1b, among the surfaces of the capacitor body 1, and is connected to the first via conductor 5. In the present example embodiment, the first via conductor 5 is exposed to the first main surface 1a of the capacitor body 1, and the first outer electrode 11 is provided on the first main surface 1a of the capacitor body 1. More specifically, the first outer electrode 11 is provided at a position overlapping with the first via conductor 5 in the lamination direction T. The number of the first outer electrodes 11 is the same as the number of the first via conductors 5, and is two in the example illustrated in FIGS. 1A and 1B. However, the number of the first outer electrodes 11 is not limited to two. As described above, the first via conductor 5 is electrically connected to the plurality of first inner electrodes 3, and therefore the first outer electrode 11 is electrically connected to the plurality of first inner electrodes 3.

The second outer electrode 12 is provided on at least one of the main surfaces of the capacitor body 1 and is connected to the second via conductor 6. In the present example embodiment, the second via conductor 6 is exposed to the first main surface 1a of the capacitor body 1. As with the first outer electrode 11, the second outer electrode 12 is provided on the first main surface 1a of the capacitor body 1. More specifically, the second outer electrode 12 is provided at a position overlapping with the second via conductor 6 in the lamination direction T. The number of the second outer electrodes 12 is the same as the number of the second via conductors 6, and is two in the example illustrated in FIGS. 1A and 1B. However, the number of the second outer electrodes 12 is not limited to two. As described above, the second via conductor 6 is electrically connected to the plurality of second inner electrodes 4, and therefore the second outer electrode 12 is electrically connected to the plurality of second inner electrodes 4.

The first via conductor 5 and the second via conductor 6 may also be exposed to the second main surface 1b of the capacitor body 1. Moreover, the first outer electrode 11 and the second outer electrode 12 may also be provided on the second main surface 1b.

The first outer electrode 11 and the second outer electrode 12 can be made of any material. In the present example embodiment, the first outer electrode 11 and the second outer electrode 12 are plated electrodes formed by plating using a rotary plating method. Examples of the material of the plated electrodes include Cu, Ni, Sn, or the like. The plated electrodes may include a single layer or a plurality of layers.

The first metal layers 21 are provided on the side surfaces of the capacitor body 1 among the surfaces thereof, and are electrically connected to the first via conductors 5. In the present example embodiment, as illustrated in FIGS. 1A and 1B, the first metal layers 21 are provided at the corner position that spans from the first side surface 1c to the second side surface 1d of the capacitor body 1, and at the corner position that spans from the third side surface 1e to the fourth side surface 1f. However, the positions where the first metal layers 21 are provided are not limited to the positions illustrated in FIGS. 1A and 1B.

The second metal layers 22 are provided on the side surfaces of the capacitor body 1 among the surfaces thereof, and are electrically connected to the second via conductors 6. In the present example embodiment, as illustrated in FIGS. 1A and 1B, the second metal layers 22 are provided at the corner position that spans from the second side surface 1d to the third side surface 1e of the capacitor body 1, and at the corner position that spans from the fourth side surface 1f to the first side surface 1c. However, the positions where the second metal layers 22 are provided are not limited to the positions illustrated in FIGS. 1A and 1B.

The first metal layer 21 and the second metal layer 22 can be made of any material. In the present example embodiment, the first metal layer 21 and the second metal layer 22 are, for example, plated layers formed by plating using the rotary plating method. Examples of the material of the plated layers include Cu, Ni, Sn, or the like. The plated layers may include a single layer or a plurality of layers.

In the multilayer ceramic capacitor 100 according to the present example embodiment, the first connection layers 31 to electrically connect the first via conductors 5 and the first metal layers 21 and the second connection layers 32 to electrically connect the second via conductors 6 and the second metal layers 22 are provided inside the capacitor body 1. The first connection layer 31 and the second connection layer 32 have a planar shape extending in a direction orthogonal or substantially orthogonal to the lamination direction T.

In the present example embodiment, the first connection layers 31 are provided in the same layer as the second inner electrode 4, as illustrated in FIG. 4B. The first connection layers 31 may be provided in all or only some of the layers in which the second inner electrodes 4 are provided. The second connection layers 32 are provided in the same layer as the first inner electrode 3, as illustrated in FIG. 4A. The second connection layers 32 may be provided in all or only some of the layers in which the first inner electrodes 3 are provided.

As illustrated in FIG. 4B, the first connection layers 31 are in contact with the first via conductors 5, but are spaced apart from the second inner electrode 4. As illustrated in FIG. 4A, the second connection layers 32 are in contact with the second via conductors 6, but are spaced apart from the first inner electrode 3.

The first connection layer 31 and the second connection layer 32 may have any shape. In the present example embodiment, as illustrated in FIG. 4B, the first connection layer 31 has a quadrant shape. As illustrated in FIG. 4A, the second connection layer 32 also has a quadrant shape.

The conductive first connection layer 31 and second connection layer 32 may be made of any material, and may be made of the same material as that of the first inner electrode 3 and the second inner electrode 4, for example.

In an example of a manufacturing process of the multilayer ceramic capacitor 100, the first connection layer 31 and the second connection layer 32 are exposed on the side surface of the capacitor body 1 before the first metal layer 21 and the second metal layer 22 are provided. The first metal layer 21 is provided so as to cover the first connection layer 31 exposed on the side surface of the capacitor body 1. The second metal layer 22 is also provided so as to cover the second connection layer 32 exposed to the side surface of the capacitor body 1.

The shape of the first metal layer 21 can be changed by changing the shape of the portion of the first connection layer 31 that is exposed on the side surface of the capacitor body 1. Similarly, the shape of the second metal layer 22 can be changed by changing the shape of the portion of the second connection layer 32 that is exposed on the side surface of the capacitor body 1.

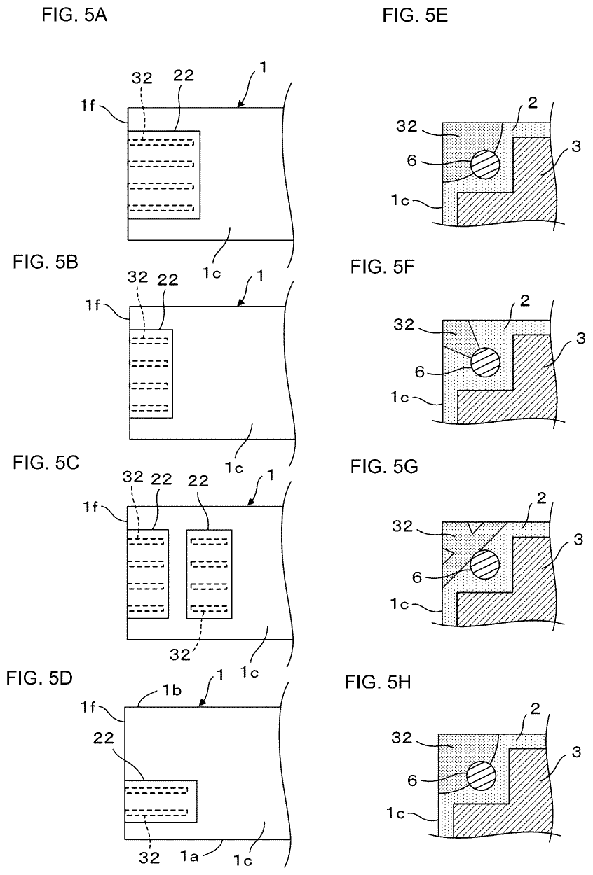

FIG. 5A is a partially enlarged view illustrating the positional relationship between the second metal layer 22 and the second connection layer 32 in the multilayer ceramic capacitor 100 illustrated in FIGS. 1 to 3. FIGS. 5B, 5C, and 5D are partially enlarged views, each illustrating the positional relationship between the second metal layer 22 and the second connection layer 32 that are different in shape from FIG. 5A. FIGS. 5E to 5H are partially enlarged views illustrating examples of the shape of the second connection layer 32 corresponding to FIGS. 5A to 5D, respectively. FIGS. 5E to 5H also illustrate portions of the dielectric layer 2, the first inner electrode 3, and the second via conductor 6.

In a configuration illustrated in FIG. 5B, the area of the second metal layer 22 is smaller than that in a configuration illustrated in FIG. 5A. As can be seen from comparison between FIGS. 5E and 5F, the area of the second metal layer 22 can be reduced by reducing the area of the portion of the second connection layer 32 exposed to the side surface of the capacitor body 1. Although not illustrated, the same holds true for the first metal layer 21 and the first connection layer 31.

In a configuration illustrated in FIG. 5C, two second metal layers 22 are provided on one side surface of the capacitor body 1. The two second metal layers 22 are provided at positions spaced apart from each other. FIG. 5C illustrates a state where the two second metal layers 22 are provided on the first side surface 1c of the capacitor body 1. It is also possible, however, to provide two second metal layers 22 on the second side surface 1d, the third side surface 1e, and the fourth side surface 1f. To provide such a configuration, the second connection layer 32 has a shape exposed at two locations on one side surface of the capacitor body 1, as illustrated in FIG. 5G. Although not illustrated, the same holds true for the first metal layer 21 and the first connection layer 31. The number of the first metal layers 21 and the number of the second metal layers 22 provided on one side surface of the capacitor body 1 are not limited to two, and may be, for example, more than or equal to three.

In a configuration illustrated in FIG. 5D, the second metal layer 22 is provided only in a region on the first main surface 1a side where the first outer electrode 11 and the second outer electrode 12 are provided on the side surface of the capacitor body 1. Specifically, when the side surface of the capacitor body 1 is divided into the region on the first main surface 1a side and a region on the second main surface 1b side, the second metal layer 22 is provided only in the region on the first main surface 1a side. In this case, the second connection layer 32 may be provided only in the layer on the first main surface 1a side in the lamination direction T. As illustrated in FIG. 5H, the shape of the second connection layer 32 may be the same or substantially the same as the shape of the second connection layer 32 illustrated in FIG. 5B.

As will be described later, when mounting the multilayer ceramic capacitor 100 according to the present example embodiment on a mounting substrate, the first metal layer 21 and the second metal layer 22 can also be joined to land electrodes on the mounting substrate using solder. In the configuration illustrated in FIG. 5D, the first metal layer 21 and the second metal layer 22 are not provided in regions where soldering is not performed when mounting the multilayer ceramic capacitor 100, thus making it possible to simplify the configuration and reduce manufacturing costs.

In the multilayer ceramic capacitor 100 according to the present example embodiment, the first metal layer 21 electrically connected to the first via conductor 5 and the second metal layer 22 electrically connected to the second via conductor 6 are provided on the side surface of the capacitor body 1. This enables more reliable formation of the outer electrodes by rotary plating. As will be described later, during rotary plating, plating can be performed in the plating formation region not only when the conductive medium comes into contact with the plating formation region on the surface of the capacitor body 1 where the first via conductor 5 and the second via conductor 6 are exposed, but also when the conductive medium comes into contact with the first metal layer 21 and the second metal layer 22. This enables more reliable formation of the first outer electrode 11 and the second outer electrode 12.

Furthermore, in the multilayer ceramic capacitor 100 according to the present example embodiment, during mounting on the mounting substrate, not only the first outer electrode 11 and the second outer electrode 12 but also the first metal layer 21 and the second metal layer 22 are joined to the land electrodes on the mounting substrate, thus enabling stable mounting.

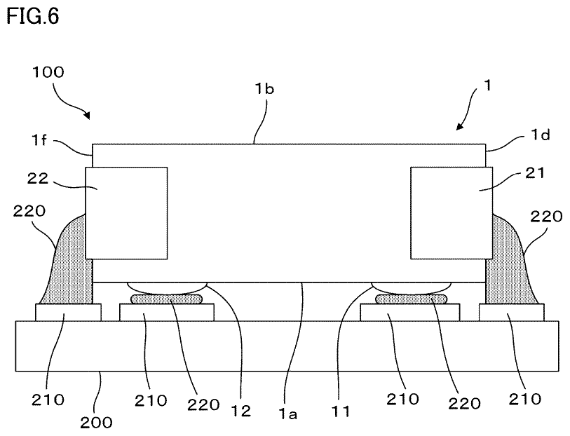

FIG. 6 is a side view schematically illustrating the multilayer ceramic capacitor 100 according to the present example embodiment mounted on a mounting substrate 200. The first outer electrode 11 and the second outer electrode 12 of the multilayer ceramic capacitor 100 are each bonded with a solder 220 to a land electrode 210 on the mounting substrate 200. The first metal layer 21 and the second metal layer 22 provided on the side surfaces of the capacitor body 1 are each bonded with the solder 220 to the land electrode 210 on the mounting substrate 200. In addition to the first outer electrode 11 and the second outer electrode 12, the first metal layer 21 and the second metal layer 22 are also bonded to the land electrodes 210 on the mounting substrate 200, thus enabling more stable mounting.

By bonding the first metal layer 21 and the second metal layer 22 to the land electrodes 210 on the mounting substrate 200 with the solder 220, it can also be visually checked if the multilayer ceramic capacitor 100 is mounted.

### Modification 1 of First Example Embodiment

As illustrated in FIGS. 4A and 4B, the first connection layers 31 and the second connection layers 32 are alternately provided in different layers. It is also possible, however, to provide a configuration in which the first connection layers 31 and the second connection layers 32 are provided in the same layer.

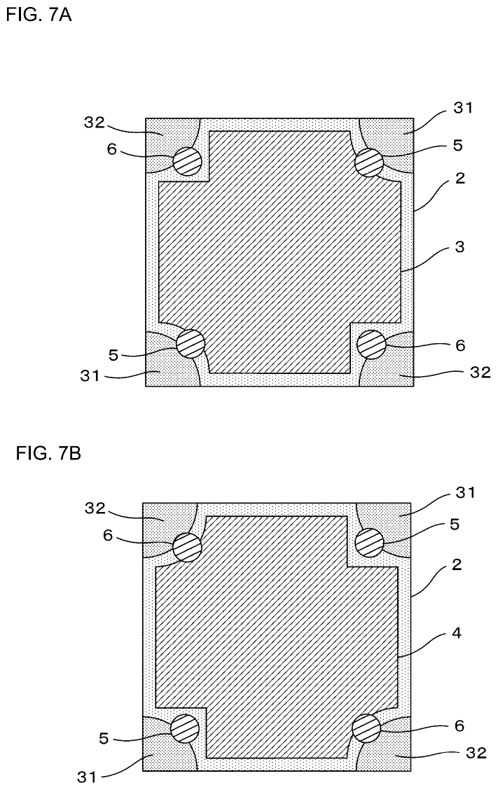

FIG. 7A is a plan view schematically illustrating the first inner electrode 3 and FIG. 7B is a plan view schematically illustrating the second inner electrode 4 when the first connection layers 31 and the second connection layers 32 are provided in the same layer. FIGS. 7A and 7B also illustrate the dielectric layer 2, the first via conductors 5, the second via conductors 6, the first connection layers 31, and the second connection layers 32.

As illustrated in FIG. 7A, the first connection layers 31 are provided, together with the second connection layers 32, in the layer in which the first inner electrode 3 is provided. The first connection layers 31 are in contact with the first via conductors 5 and are electrically connected to the first inner electrode 3 through the first via conductors 5. The first connection layers 31 are not in direct contact with the first inner electrode 3.

As illustrated in FIG. 7B, the second connection layers 32 are provided, together with the first connection layer 31, in the layer in which the second inner electrode 4 is provided. The second connection layers 32 are in contact with the second via conductors 6 and are electrically connected to the second inner electrode 4 through the second via conductors 6. The second connection layers 32 are not in direct contact with the second inner electrode 4.

In this example, the number of the first connection layers 31 connecting the first via conductors 5 and the first metal layers 21 and the number of the second connection layers 32 connecting the second via conductors 6 and the second metal layers 22 are greater than those in the configuration example illustrated in FIGS. 4A and 4B. This enables more reliable electrical connection between the first via conductors 5 and the first metal layers 21 through the first connection layers 31 and between the second via conductors 6 and the second metal layers 22 through the second connection layers 32. This configuration also enables more reliable formation of the first outer electrode 11 and the second outer electrode 12 by rotary plating.

In addition, since the first connection layers 31 are not in direct contact with the first inner electrode 3, it is possible to reduce or prevent intrusion of the plating solution from the outside to the inside during manufacturing, and to reduce or prevent intrusion of moisture and the like from the outside to the inside of a finished product. Specifically, in a configuration in which the first connection layer 31 is in direct contact with the first inner electrode 3, the plating solution, moisture, and the like easily penetrate from the outside to the inside of the capacitor body 1 through the first connection layer 31 and the first inner electrode 3. However, since the first connection layer 31 is spaced apart from the first inner electrode 3, the penetration of the plating solution, moisture, and the like into the inside can be reduced or prevented. Similarly, since the second connection layer 32 is not in direct contact with the second inner electrode 4, penetration of the plating solution, moisture, and the like from the outside to the inside of the capacitor body 1 can be reduced or prevented.

When the configuration illustrated in FIGS. 4A and 4B is compared with the configuration illustrated in FIGS. 7A and 7B, the inner electrode and the connection layer are completely separated in one layer. Therefore, the configuration illustrated in FIGS. 4A and 4B can more effectively reduce or prevent the penetration of the plating solution, moisture, and the like from the outside to the inside of the capacitor body 1.

### Modification 2 of First Example Embodiment

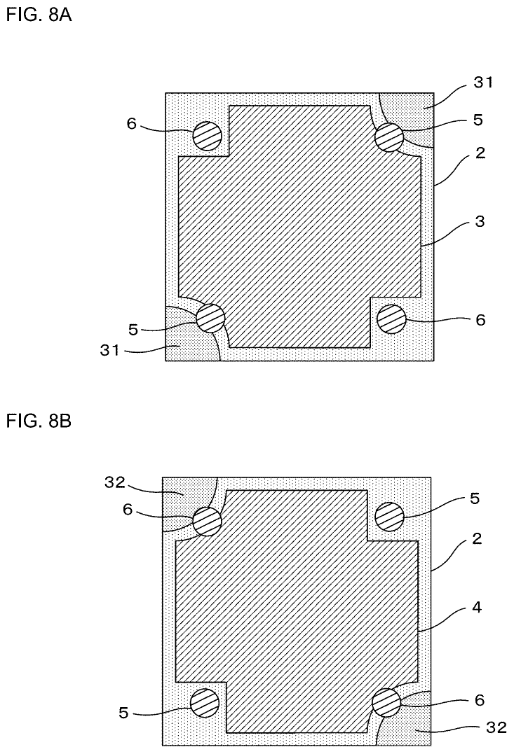

In the configuration illustrated in FIGS. 4A and 4B, the second connection layers 32 are provided in the layer in which the first inner electrode 3 is provided, and the first connection layers 31 are provided in the layer in which the second inner electrode 4 is provided. However, it is also possible to provide a configuration in which the first connection layers 31 are provided in the layer in which the first inner electrode 3 is provided, and the second connection layers 32 are provided in the layer in which the second inner electrode 4 is provided. In this case, FIG. 8A is a plan view schematically illustrating the first inner electrode 3 and the first connection layers 31, and FIG. 8B is a plan view schematically illustrating the second inner electrode 4 and the second connection layers 32. FIGS. 8A and 8B also illustrate the dielectric layer 2, the first via conductors 5, and the second via conductors 6.

As illustrated in FIG. 8A, the first connection layers 31 are in contact with the first via conductors 5 and electrically connected to the first inner electrode 3 through the first via conductors 5. The first connection layers 31 are not in direct contact with the first inner electrode 3. As illustrated in FIG. 8A, the second connection layers 32 are not provided in the layer in which the first inner electrode 3 is provided.

As illustrated in FIG. 8B, the second connection layers 32 are in contact with the second via conductors 6 and electrically connected to the second inner electrode 4 through the second via conductors 6. The second connection layers 32 are not in direct contact with the second inner electrode 4. As illustrated in FIG. 8B, the first connection layers 31 are not provided in the layer in which the second inner electrode 4 is provided.

The configuration illustrated in FIGS. 8A and 8B can reduce the number of first connection layers 31 and second connection layers 32 to about half that of the configuration illustrated in FIGS. 7A and 7B. This makes it possible to reduce or prevent the intrusion of the plating solution from the outside to the inside during manufacturing, and also to reduce or prevent the intrusion of moisture and the like from the outside to the inside of a finished product. Specifically, the plating solution and moisture easily intrude into the inside at the locations where the first connection layers 31 and the second connection layers 32 are exposed on the side surfaces of the capacitor body 1. However, the intrusion of the plating solution, moisture, and the like into the inside is reduced or prevented by reducing the number of the first connection layers 31 and the second connection layers 32. The same holds true for the configuration illustrated in FIGS. 4A and 4.

### Method for Manufacturing Multilayer Ceramic Capacitor

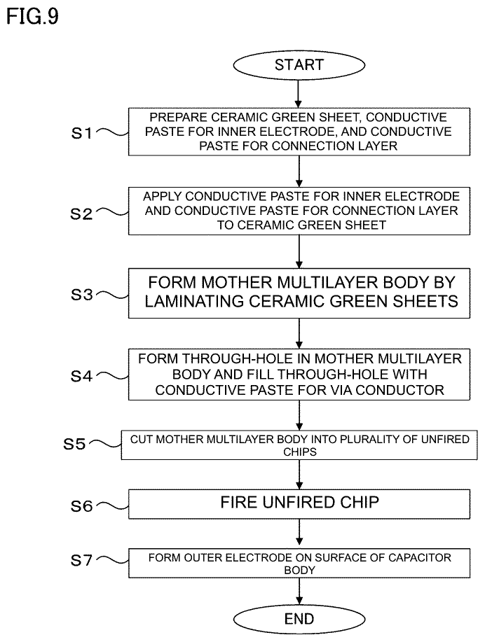

An example of a method for manufacturing the multilayer ceramic capacitor 100 described above will be described with reference to a flowchart illustrated in FIG. 9.

In step S1 of FIG. 9, ceramic green sheets, a conductive paste for inner electrodes, and a conductive paste for connection layers are prepared. Any known ceramic green sheet can be used, which can be obtained, for example, by applying a ceramic slurry including ceramic powder, a resin component, and a solvent onto a substrate, followed by drying.

The conductive paste for inner electrodes is a conductive paste for forming the first inner electrode 3 and the second inner electrode 4, and any known one can be used. The conductive paste for inner electrodes includes particles of metals such as, for example, Ni, Cu, Ag, Pd, Pt, Fe, Ti, Cr, Sn or Au, or their precursors, and a solvent. The conductive paste for inner electrodes may further include a resin component that defines and functions as a dispersant or binder.

The conductive paste for connection layers is a conductive paste for forming the first connection layer 31 and the second connection layer 32, and may be the same as the conductive paste for inner electrodes. However, a conductive paste different from the conductive paste for inner electrodes may be used as the conductive paste for connection layers.

In step S2 following step S1, the conductive paste for inner electrodes and the conductive paste for connection layers are applied to the prepared ceramic green sheet by a method such as printing, for example. The conductive paste for inner electrodes is applied at the positions where the first inner electrode 3 and the second inner electrode 4 are to be formed. The conductive paste for connection layers is applied at the positions where the first connection layer 31 and the second connection layer 32 are to be formed. Here, an electrode pattern and a connection layer pattern are formed, which enable a plurality of multilayer ceramic capacitors 100 to be manufactured at the same time.

In step S3 following step S2, a mother multilayer body is formed by laminating a plurality of the ceramic green sheets having the conductive paste for inner electrodes and the conductive paste for connection layers applied thereto. To form the mother multilayer body, a ceramic green sheet including no electrode pattern and no connection layer pattern formed thereon may be provided on the outer side portion in the lamination direction. Here, the mother multilayer body is formed by laminating the plurality of ceramic green sheets, followed by pressing in the lamination direction. Any method can be used for the pressing. For example, a rigid press or an isostatic press can be used.

In step S4 following step S3, a plurality of through-holes extending in the lamination direction are formed in the mother multilayer body, and the plurality of through-holes thus formed are filled with a conductive paste for via conductors. The through-holes can be formed by any method, for example, by using a laser. The conductive paste for via conductors is a conductive paste for forming the first via conductors 5 and the second via conductors 6, which includes particles of metals such as, for example, Ni, Cu, Ag, Pd, Pt, Fe, Ti, Cr, Sn or Au or their precursors, and a solvent. The conductive paste for via conductors may further include a resin component that defines and functions as a dispersant or binder.

In step S5 following step S4, the mother multilayer body is cut into a plurality of unfired chips. The mother multilayer body can be cut by press cutting, cutting with a dicing machine, laser cutting or the like, for example.

In step S6 following step S5, the unfired chips are fired to produce the capacitor body 1. The first via conductor 5 and the second via conductor 6 are exposed on the first main surface 1a of the capacitor body 1 thus produced, and the first connection layer 31 and the second connection layer 32 are exposed on the side surfaces thereof.

In step S7 following step S6, the first outer electrode 11 and the second outer electrode 12 are formed on the surface of the capacitor body 1. Here, the first outer electrode 11 and the second outer electrode 12 are formed by plating using a barrel plating method as an example of the rotary plating method. Specifically, a number of capacitor bodies 1 and a number of conductive media are placed in a rotatable barrel, and the barrel is rotated in a plating solution, thus applying an electric current to form plating in a plating formation region where the first via conductor 5 and the second via conductor 6 are exposed on the first main surface 1a of the capacitor body 1. The conductive media are each a spherical body made of metal, for example. A plated film is formed in the plating formation area to form the first outer electrode 11 and the second outer electrode 12 as plated electrodes.

By the plating process using the rotary plating method, plating films are also formed in the region where the first connection layer 31 and the second connection layer 32 are exposed on the side surfaces of the capacitor body 1, thus forming the first metal layer 21 and the second metal layer 22 as plated layers.

The plating films in the plating formation region are formed not only when the electric current is applied by the conductive medium coming into contact with the first via conductor 5 and the second via conductor 6 exposed on the first main surface 1a of the capacitor body 1 but also when the electric current is applied by the conductive medium coming into contact with the first connection layer 31 and the second connection layer 32 exposed on the side surfaces of the capacitor body 1, and also when the electric current is applied by the conductive medium coming into contact with the first metal layer 21 and the second metal layer 22 formed on the side surfaces of the capacitor body 1 by plating. Therefore, the first outer electrode 11 and the second outer electrode 12 can be formed more reliably by plating using the rotary plating method.

As described above, in the multilayer ceramic capacitor 100 according to the present example embodiment, the first metal layer 21 and the second metal layer 22 are provided at positions across the two side surfaces of the capacitor body 1. Therefore, compared to a configuration in which the first metal layer 21 and the second metal layer 22 are provided only on one side surface of the capacitor body 1, there are more chances of the conductive medium coming into contact with the first metal layer 21 and the second metal layer 22 during rotary plating. This enables more reliable formation of the first outer electrode 11 and the second outer electrode 12.

The multilayer ceramic capacitor 100 is obtained by the manufacturing method described above.

### Second Example Embodiment

In the multilayer ceramic capacitor 100 according to the first example embodiment, the number of the first outer electrodes 11 and the number of the second outer electrodes 12 are each two, but are not limited to two as described above.

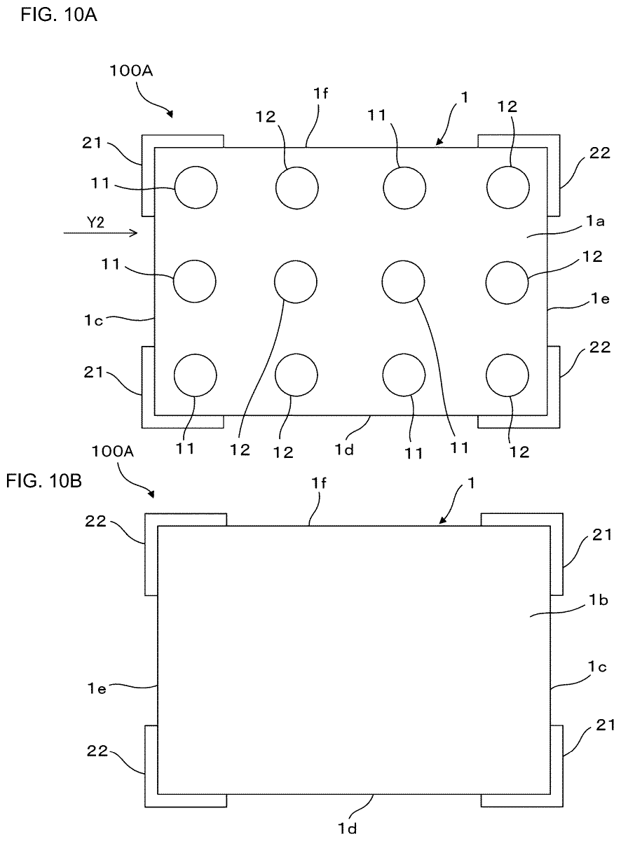

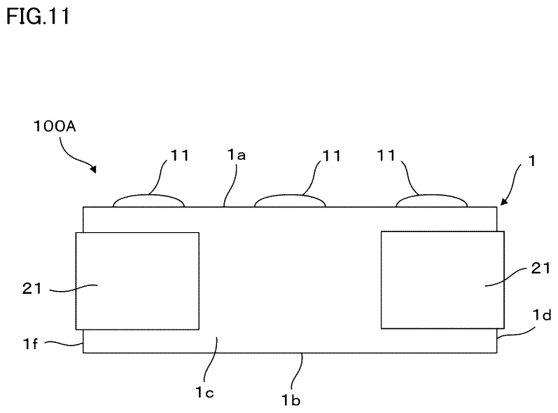

FIG. 10A is a top view schematically illustrating a multilayer ceramic capacitor 100A according to a second example embodiment of the present invention. FIG. 10B is a bottom view schematically illustrating the multilayer ceramic capacitor 100A. FIG. 11 is a side view of the multilayer ceramic capacitor 100A illustrated in FIGS. 10A and 10B as viewed in a direction of arrow Y2.

In the multilayer ceramic capacitor 100A according to the second example embodiment, six first outer electrodes 11 and six second outer electrodes 12 are provided. A total of twelve outer electrodes including the first outer electrodes 11 and the second outer electrodes 12 are arranged in a matrix. Here, four outer electrodes are arranged in a row direction (horizontal direction in FIG. 10A) and three are arranged in a column direction (vertical direction in FIG. 10A). However, the number of the outer electrodes in the row direction is not limited to four, and the number of the outer electrodes in the column direction is not limited to three.

As illustrated in FIG. 10A, the first outer electrodes 11 and the second outer electrodes 12 are arranged alternately in the row direction, while only the first outer electrodes 11 or only the second outer electrodes 12 are arranged in the column direction. However, the arrangement pattern of the first outer electrodes 11 and the second outer electrodes 12 is not limited to the arrangement pattern illustrated in FIG. 10A.

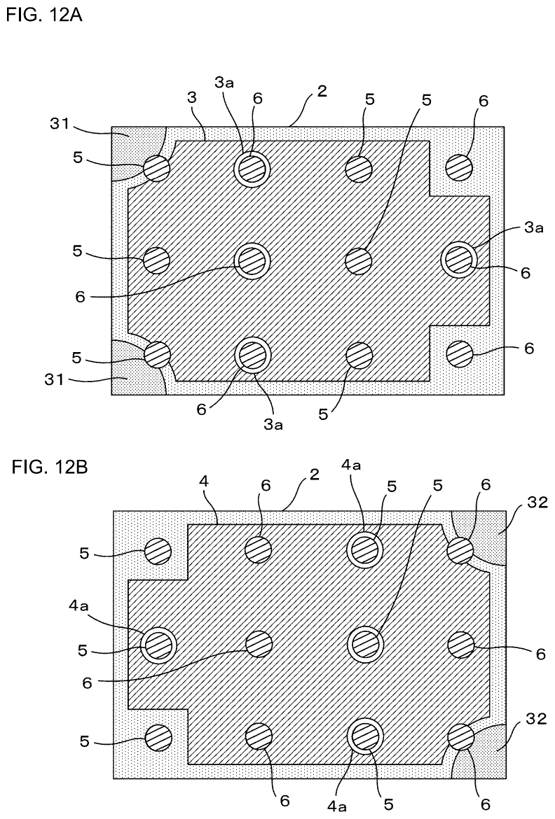

FIG. 12A is a plan view schematically illustrating a first inner electrode 3. FIG. 12B is a plan view schematically illustrating a second inner electrode 4. FIGS. 12A and 12B also illustrate a dielectric layer 2, first via conductors 5, and second via conductors 6. FIG. 12A also illustrates first connection layers 31. FIG. 12B also illustrates second connection layers 32.

The first inner electrode 3 includes a plurality of first through-holes 3a provided therein to insert the second via conductors 6. The second inner electrode 4 includes a plurality of second through-holes 4a provided therein to insert the first via conductors 5.

As illustrated in FIG. 12B, the first via conductors 5 provided at positions overlapping with the second inner electrode 4 in the lamination direction T are inserted through the second through-holes 4a formed in the second inner electrode 4, and are insulated from the second inner electrode 4. Similarly, as illustrated in FIG. 12A, the second via conductors 6 provided at positions overlapping with the first inner electrode 3 in the lamination direction T are inserted through the first through-holes 3a formed in the first inner electrode 3, and are insulated from the first inner electrode 3.

As illustrated in FIG. 12A, the first connection layers 31 are provided in the layer in which the first inner electrode 3 is provided. The first connection layers 31 are in contact with the first via conductors 5 and electrically connected to the first inner electrode 3 through the first via conductors 5. The first connection layers 31 are not in direct contact with the first inner electrode 3. As illustrated in FIG. 12A, the second connection layers 32 are not provided in the layer in which the first inner electrode 3 is provided.

As illustrated in FIG. 12B, the second connection layers 32 are provided in the layer in which the second inner electrode 4 is provided. The second connection layers 32 are in contact with the second via conductors 6 and electrically connected to the second inner electrode 4 through the second via conductors 6. The second connection layers 32 are not in direct contact with the second inner electrode 4. As illustrated in FIG. 12B, the first connection layers 31 are not provided in the layer in which the second inner electrode 4 is provided.

In the multilayer ceramic capacitor 100A according to the present example embodiment, as in the multilayer ceramic capacitor 100 according to the first example embodiment, the first metal layers 21 electrically connected to the first via conductors 5 and the second metal layers 22 electrically connected to the second via conductors 6 are provided on the side surfaces of the capacitor body 1. This enables more reliable formation of the first outer electrodes 11 and the second outer electrodes 12 by rotary plating.

### Third Example Embodiment

In the multilayer ceramic capacitor 100 according to the first example embodiment and the multilayer ceramic capacitor 100A according to the second example embodiment described above, the first metal layers 21 and the second metal layers 22 are provided on the side surfaces of the capacitor body 1. However, it is also possible to provide a configuration in which only the first metal layers 21 are provided.

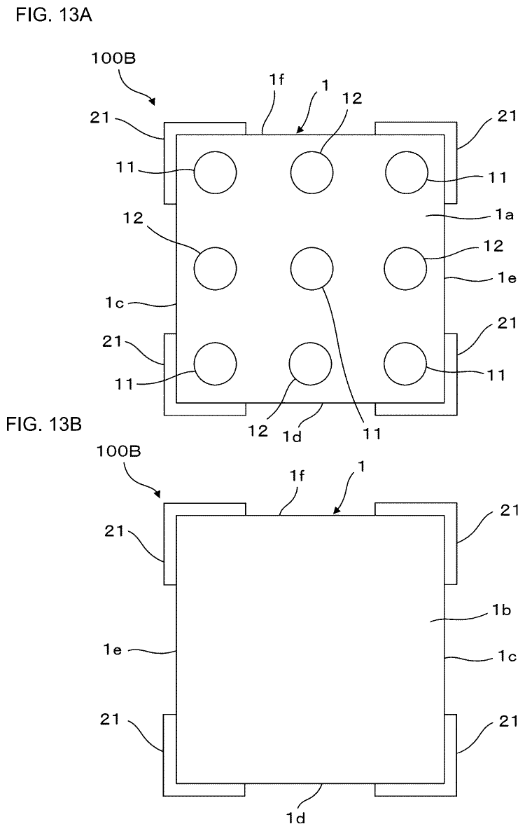

FIG. 13A is a top view schematically illustrating a multilayer ceramic capacitor 100B according to a third example embodiment of the present invention. FIG. 13B is a bottom view schematically illustrating a multilayer ceramic capacitor 100B according to the third example embodiment.

In the multilayer ceramic capacitor 100B according to the third example embodiment, five first outer electrodes 11 and four second outer electrodes 12 are provided. A total of nine outer electrodes including the first outer electrodes 11 and the second outer electrodes 12 are arranged in a matrix. Here, three outer electrodes are arranged in the row direction and three are arranged in the column direction. However, the number of the outer electrodes in the row direction is not limited to three, and the number of the outer electrodes in the column direction is not limited to three.

In the present example embodiment, the first outer electrodes 11 are provided at the four corner positions and the central position and the second outer electrodes 12 are provided at other positions among the nine arrangement positions of three rows and three columns.

The multilayer ceramic capacitor 100B according to the present example embodiment includes first metal layers 21 provided on the side surfaces of a capacitor body 1, but includes no second metal layers. In the present example embodiment, the first metal layers 21 are provided at four locations: a corner position spanning from the first side surface 1c to the second side surface 1d of the capacitor body 1, a corner position spanning from the second side surface 1d to the third side surface 1e, a corner position spanning from the third side surface 1e to the fourth side surface 1f, and a corner position spanning from the fourth side surface if to the first side surface 1c. However, the positions where the first metal layers 21 are provided are not limited to the positions described above, and the number of the first metal layers 21 is not limited to four.

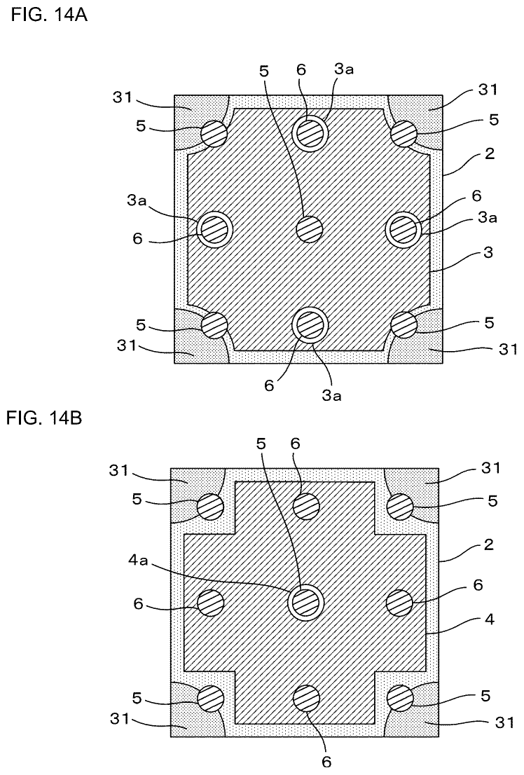

FIG. 14A is a plan view schematically illustrating a first inner electrode 3. FIG. 14B is a plan view schematically illustrating a second inner electrode 4. FIGS. 14A and 14B also illustrate a dielectric layer 2, first via conductors 5, second via conductors 6, and first connection layers 31.

The first inner electrode 3 includes a plurality of first through-holes 3a provided therein to insert the second via conductors 6. The second inner electrode 4 includes a second through-hole 4a provided therein to insert the first via conductor 5.

As illustrated in FIG. 14B, the first via conductor 5 provided at a position overlapping with the second inner electrode 4 in the lamination direction T is inserted into the second through-hole 4a provided in the second inner electrode 4, and is insulated from the second inner electrode 4. As illustrated in FIG. 14A, the second via conductors 6 provided at positions overlapping with the first inner electrode 3 in the lamination direction T are inserted into the first through-holes 3a provided in the first inner electrode 3, and are insulated from the first inner electrode 3.

As illustrated in FIGS. 14A and 14B, the first connection layers 31 are provided in the layer in which the first inner electrode 3 is provided and in the layer in which the second inner electrode 4 is provided, respectively. The first connection layers 31 are provided at four corner positions of the rectangular or substantially rectangular dielectric layer 2 when viewed in the lamination direction T. The first connection layers 31 are each in contact with the nearest first via conductor 5 and electrically connected to the first inner electrode 3 through the first via conductor 5. The first connection layers 31 are not in direct contact with the first inner electrode 3.

In the multilayer ceramic capacitor 100B according to the present example embodiment, the first metal layers 21 electrically connected to the first via conductors 5 are provided on the side surfaces of the capacitor body 1. This enables more reliable formation of the first outer electrodes 11 by rotary plating.

### Fourth Example Embodiment

As described above, in the multilayer ceramic capacitor 100B according to the third example embodiment, a total of nine outer electrodes are provided in a matrix, and only the first metal layers 21 are provided on the side surfaces of the capacitor body 1.

In a multilayer ceramic capacitor 100C according to a fourth example embodiment of the present invention, on the other hand, a total of nine outer electrodes are arranged in a matrix, and first metal layers 21 and second metal layers 22 are provided on the side surfaces of a capacitor body 1.

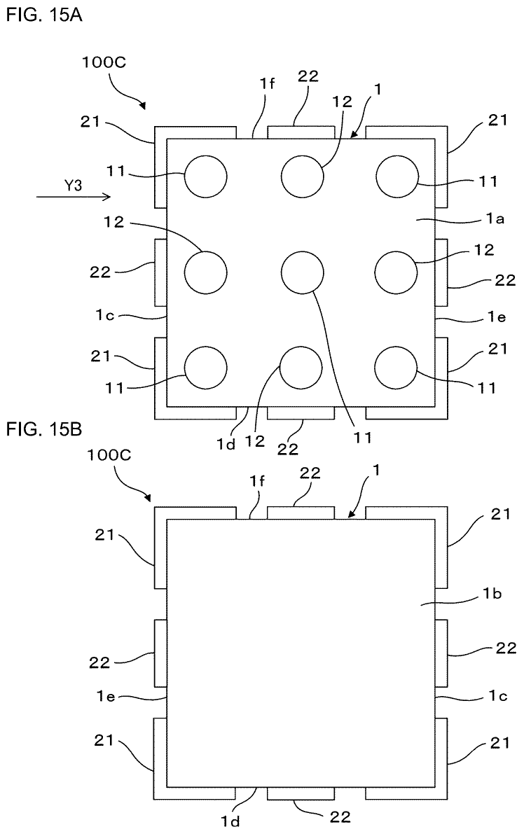

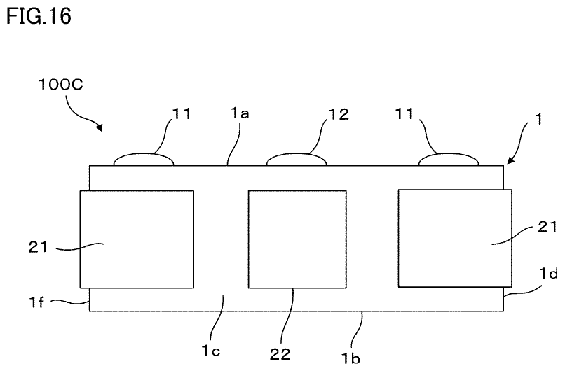

FIG. 15A is a top view schematically illustrating the multilayer ceramic capacitor 100C according to the fourth example embodiment. FIG. 15B is a bottom view schematically illustrating the multilayer ceramic capacitor 100C. FIG. 16 is a side view of the multilayer ceramic capacitor 100C illustrated in FIGS. 15A and 15B as viewed in a direction of arrow Y3.

As with the multilayer ceramic capacitor 100B according to the third example embodiment, the multilayer ceramic capacitor 100C according to the fourth example embodiment is also provided with five first outer electrodes 11 and four second outer electrodes 12. As illustrated in FIG. 15A, arrangement positions of the first outer electrodes 11 and the second outer electrodes 12 are the same or substantially the same as those in the multilayer ceramic capacitor 100B according to the third example embodiment.

The arrangement positions of the first metal layers 21 are also the same or substantially the same as those in the multilayer ceramic capacitor 100B according to the third example embodiment. Specifically, the first metal layers 21 are provided at four corner positions across two side surfaces of the capacitor body 1.

In the present example embodiment, the second metal layers 22 are provided between two first metal layers 21 on each of the first side surface 1c, the second side surface 1d, the third side surface 1e, and the fourth side surface if of the capacitor body 1. Specifically, as illustrated in FIG. 16, the second metal layer 22 provided on the first side surface 1c of the capacitor body 1 is located between the two first metal layers 21 provided on the first side surface 1c. Similarly, the second metal layer 22 provided on the second side surface 1d of the capacitor body 1 is located between the two first metal layers 21 provided on the second side surface 1d. The second metal layer 22 provided on the third side surface 1e of the capacitor body 1 is located between the two first metal layers 21 provided on the third side surface 1e. The second metal layer 22 provided on the fourth side surface if of the capacitor body 1 is located between the two first metal layers 21 provided on the fourth side surface 1f.

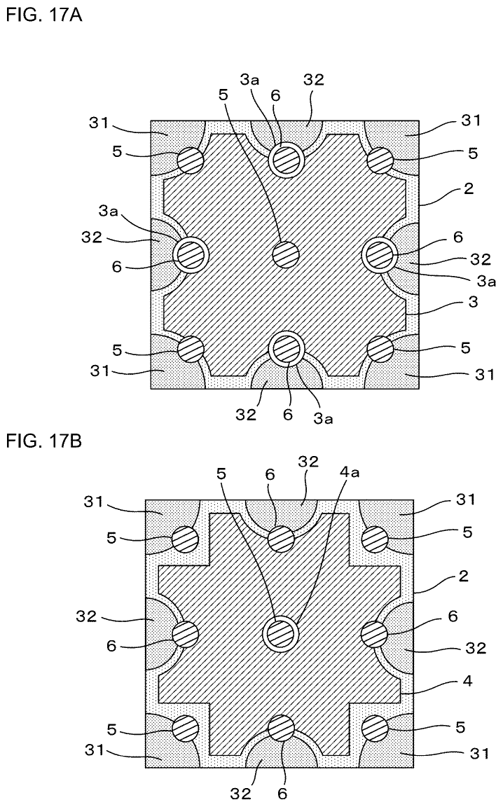

FIG. 17A is a plan view schematically illustrating a first inner electrode 3. FIG. 17B is a plan view schematically illustrating a second inner electrode 4. FIGS. 17A and 17B also illustrate a dielectric layer 2, first via conductors 5, second via conductors 6, first connection layers 31, and second connection layers 32.

The first inner electrode 3 includes a plurality of first through-holes 3a provided therein to insert the second via conductors 6. The second inner electrode 4 includes a second through-hole 4a provided therein to insert the first via conductor 5.

As illustrated in FIG. 17B, the first via conductor 5 provided at a position overlapping with the second inner electrode 4 in the lamination direction T is inserted into the second through-hole 4a provided in the second inner electrode 4, and is insulated from the second inner electrode 4. As illustrated in FIG. 17A, the second via conductors 6 provided at positions overlapping with the first inner electrode 3 in the lamination direction T are inserted into the first through-holes 3a provided in the first inner electrode 3, and are insulated from the first inner electrode 3.

As illustrated in FIGS. 17A and 17B, the first connection layers 31 and the second connection layers 32 are each provided in the layer in which the first inner electrode 3 is provided and in the layer in which the second inner electrode 4 is provided. The first connection layers 31 are provided at four corner positions of the rectangular or substantially rectangular dielectric layer 2 when viewed in the lamination direction T. The first connection layers 31 are each in contact with the nearest first via conductor 5 and electrically connected to the first inner electrode 3 through the first via conductor 5. The first connection layers 31 are not in direct contact with the first inner electrode 3.

As illustrated in FIGS. 17A and 17B, the second connection layers 32 are provided at central positions on the four sides of the rectangular or substantially rectangular dielectric layer 2 when viewed in the lamination direction T. The second connection layers 32 are each in contact with the nearest second via conductor 6 and electrically connected to the second inner electrode 4 through the second via conductor 6. The second connection layers 32 are not in direct contact with the second inner electrode 4.

In the multilayer ceramic capacitor 100C according to the fourth example embodiment, as in the multilayer ceramic capacitor 100 according to the first example embodiment, the first metal layers 21 electrically connected to the first via conductors 5 and the second metal layers 22 electrically connected to the second via conductors 6 are provided on the side surfaces of the capacitor body 1. This enables more reliable formation of the first outer electrodes 11 and the second outer electrodes 12 by rotary plating.

### Modification of Fourth Example Embodiment

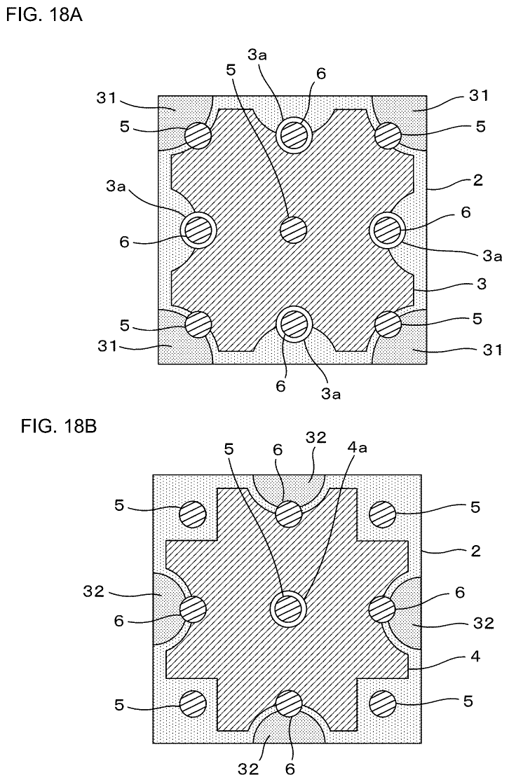

In the configuration illustrated in FIGS. 17A and 17B, the first connection layers 31 and the second connection layers 32 are each provided in the layer in which the first inner electrode 3 is provided and in the layer in which the second inner electrode 4 is provided. However, it is also possible to provide a configuration in which the first connection layer 31 is provided in the layer in which the first inner electrode 3 is provided and the second connection layer 32 is provided in the layer in which the second inner electrode 4 is provided. In this case, FIG. 18A is a plan view schematically illustrating the first inner electrode 3 and the first connection layers 31. FIG. 18B is a plan view schematically illustrating the second inner electrode 4 and the second connection layers 32. FIGS. 18A and 18B also illustrate a dielectric layer 2, first via conductors 5, and second via conductors 6. The number and arrangement positions of the first via conductors 5 and the second via conductors 6 are the same or substantially the same as the number and arrangement positions of the first via conductors 5 and the second via conductors 6 illustrated in FIGS. 17A and 17B.

As illustrated in FIG. 18A, the first connection layers 31 are each in contact with the nearest first via conductor 5 and electrically connected to the first inner electrode 3 through the first via conductor 5. The first connection layers 31 are not in direct contact with the first inner electrode 3. The arrangement positions of the first connection layers 31 when viewed in the lamination direction T are the same or substantially the same as those illustrated in FIG. 17A. As illustrated in FIG. 18A, the second connection layers 32 are not provided in the layer in which the first inner electrode 3 is provided.

As illustrated in FIG. 18B, the second connection layers 32 are each in contact with the nearest second via conductor 6 and electrically connected to the second inner electrode 4 through the second via conductor 6. The second connection layers 32 are not in direct contact with the second inner electrode 4. The arrangement positions of the second connection layers 32 when viewed in the lamination direction T are the same or substantially the same as those illustrated in FIG. 17B. As illustrated in FIG. 18B, the first connection layers 31 are not provided in the layer in which the second inner electrode 4 is provided.

The configuration illustrated in FIGS. 18A and 18B can reduce the number of the first connection layers 31 and the second connection layers 32 to about half that of the configuration illustrated in FIGS. 17A and 17B. This makes it possible to reduce or prevent the intrusion of the plating solution from the outside to the inside during manufacturing, and also to reduce or prevent the intrusion of moisture and the like from the outside to the inside of a finished product. Specifically, the plating solution and moisture easily intrude into the inside at the locations where the first connection layers 31 and the second connection layers 32 are exposed on the side surfaces of the capacitor body 1. However, the intrusion of the plating solution, moisture, and the like into the inside is reduced or prevented by reducing the number of the first connection layers 31 and the second connection layers 32.

The present invention is not limited to the above-described example embodiments, and various applications and modifications can be made within the scope of the present invention. For example, the characteristic configurations described in the example embodiments and the modifications thereof can be combined as appropriate.

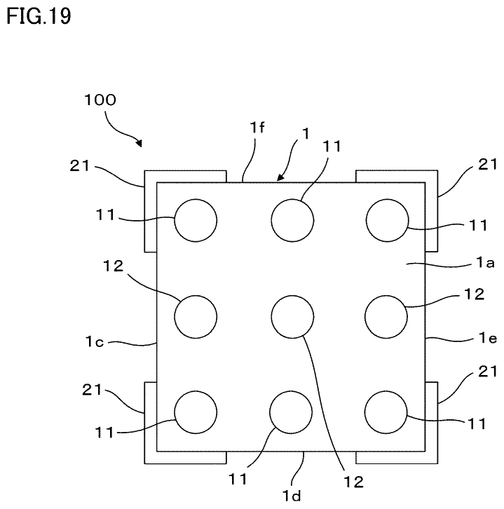

The arrangement pattern of the plurality of outer electrodes arranged in a matrix is not limited to the arrangement patterns according to the example embodiments and modifications described above. For example, when an odd number of outer electrodes are provided in the row direction and an odd number of outer electrodes are provided in the column direction, the arrangement pattern illustrated in FIG. 19 can be used. In the arrangement pattern illustrated in FIG. 19, the outer electrodes of the same type are arranged in the row direction, and the first outer electrodes 11 and the second outer electrodes 12 are arranged alternately in the column direction. However, the first outer electrodes 11 and the second outer electrodes 12 may be arranged alternately in the row direction, and the outer electrodes of the same type may be arranged in the column direction. In the arrangement pattern illustrated in FIG. 19, as in the arrangement pattern illustrated in FIGS. 13A and 13B, the only outer electrodes provided on the side surfaces of the capacitor body 1 are the first outer electrodes 11.

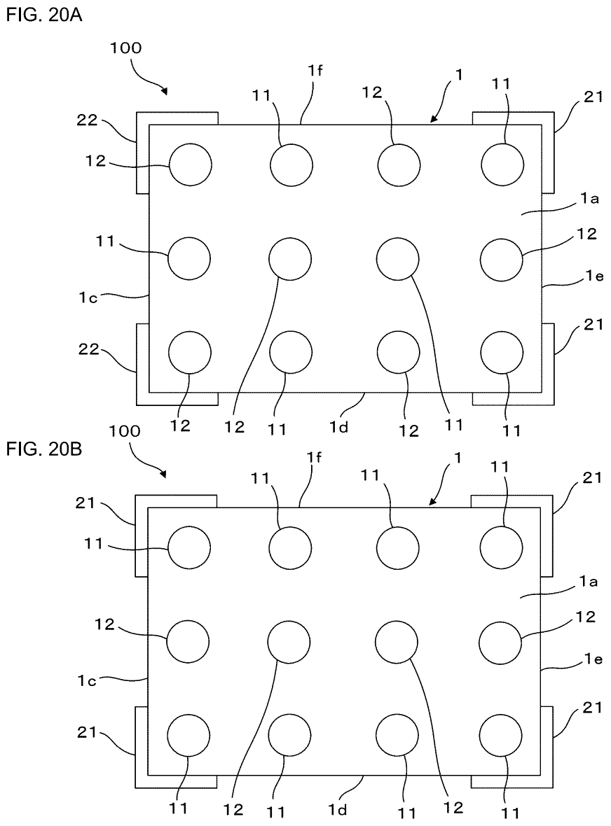

When an even number of outer electrodes are provided in the row direction and an odd number of outer electrodes are provided in the column direction, arrangement patterns illustrated in FIGS. 20A and 20B can also be used. In the arrangement pattern illustrated in FIG. 20A, the first outer electrodes 11 and the second outer electrodes 12 are alternately arranged in the row direction, and the first outer electrodes 11 and the second outer electrodes 12 are alternately arranged also in the column direction. In the arrangement pattern illustrated in FIG. 20B, outer electrodes of the same type are arranged in the row direction, and the first outer electrodes 11 and the second outer electrodes 12 are alternately arranged in the column direction. In the arrangement pattern illustrated in FIG. 20A, the first metal layers 21 and the second metal layers 22 are provided on the side surfaces of the capacitor body 1. In the arrangement pattern illustrated in FIG. 20B, on the other hand, only the first metal layers 21 are provided on the side surfaces of the capacitor body 1. Also when an odd number of outer electrodes are provided in the row direction and an even number of outer electrodes are provided in the column direction, the outer electrodes can be arranged in the same or substantially the same arrangement pattern as when an even number of outer electrodes are provided in the row direction and an odd number of outer electrodes are provided in the column direction.

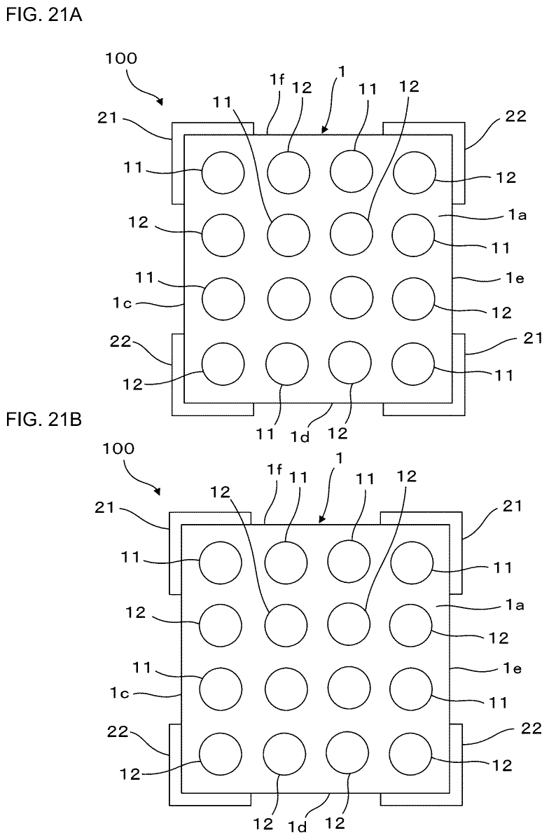

When the number of outer electrodes is greater than two rows by two columns and when an even number of outer electrodes are provided in the row direction and an even number of outer electrodes are provided in the column direction, arrangement patterns illustrated in FIGS. 21A and 21B can be used. In the arrangement pattern illustrated in FIG. 21A, the first outer electrodes 11 and the second outer electrodes 12 are alternately arranged in the row direction, and the first outer electrodes 11 and the second outer electrodes 12 are also alternately arranged in the column direction. In the arrangement pattern illustrated in FIG. 21B, outer electrodes of the same type are arranged in the row direction, and the first outer electrodes 11 and the second outer electrodes 12 are alternately arranged in the column direction. However, the first outer electrodes 11 and the second outer electrodes 12 may be alternately arranged in the row direction, and the outer electrodes of the same type may be arranged in the column direction. In the arrangement patterns illustrated in FIGS. 21A and 21B, the first metal layers 21 and the second metal layers 22 are provided on the side surfaces of the capacitor body 1.

When mounting the multilayer ceramic capacitor 100 on a mounting substrate, it is also possible to provided a configuration in which the first metal layer 21 and the second metal layer 22 are not bonded to land electrodes on the mounting substrate. In that case, the first metal layer 21 and the second metal layer 22 are unnecessary for practical use of a finished product. The first metal layer 21 and the second metal layer 22 may therefore be covered with resin or the like.

In the multilayer ceramic capacitors according to the above example embodiments and their modifications, the first connection layers 31 are provided inside the capacitor body 1 to electrically connect the first via conductors 5 and the first metal layers 21. However, the first via conductors 5 and the first metal layers 21 may be electrically connected to each other by the first inner electrode 3, without providing the first connection layers 31. In that case, the first inner electrode 3 may be configured to have a shape that extends to the side surface of the capacitor body 1. Similarly, in the multilayer ceramic capacitor including the second metal layers 22, the second via conductors 6 and the second metal layers 22 may be electrically connected to each other by the second inner electrode 4, without providing the second connection layers 32.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a capacitor body including a plurality of dielectric layers, a plurality of first inner electrodes, and a plurality of second inner electrodes that are laminated;
a first via conductor inside the capacitor body and electrically connected to the plurality of first inner electrodes;
a second via conductor inside the capacitor body and electrically connected to the plurality of second inner electrodes;
a first outer electrode on at least one of a first main surface and a second main surface of the capacitor body facing each other in a lamination direction of the plurality of dielectric layers, the plurality of first inner electrodes, and the plurality of second inner electrodes, and connected to the first via conductor;
a second outer electrode on the at least one of the first main surface and the second main surface of the capacitor body and connected to the second via conductor; and
a first metal layer on a side surface of the capacitor body other than the first main surface and the second main surface, and electrically connected to the first via conductor.

2. The multilayer ceramic capacitor according to claim 1, further comprising a first connection layer inside the capacitor body to electrically connect the first via conductor and the first metal layer.

3. The multilayer ceramic capacitor according to claim 1, wherein
the first metal layer is a plated layer; and
the first outer electrode and the second outer electrode include plated electrodes.

4. The multilayer ceramic capacitor according to claim 1, wherein each of the plurality of dielectric layers includes BaTiO₃, CaTiO₃, SrTiO₃, SrZrO₃, or CaZrO₃ as a main component.

5. The multilayer ceramic capacitor according to claim 4, wherein each of the plurality of the dielectric layers includes a Mn compound, a Fe compound, a Cr compound, a Co compound, or a Ni compound as a subcomponent.

6. The multilayer ceramic capacitor according to claim 1, wherein each of the plurality of first and second inner electrodes includes Ni, Cu, Ag, Pd, Pt, Fe, Ti, Cr, Sn or Au, or and an alloy including Ni, Cu, Ag, Pd, Pt, Fe, Ti, Cr, Sn or Au.

7. The multilayer ceramic capacitor according to claim 1, wherein a thickness of each of the plurality of first and second inner electrodes is about 0.3 μm to about 1.0 μm.

8. A multilayer ceramic capacitor comprising:
a capacitor body including a plurality of dielectric layers, a plurality of first inner electrodes, and a plurality of second inner electrodes that are laminated;
a first via conductor inside the capacitor body and electrically connected to the plurality of first inner electrodes;
a second via conductor inside the capacitor body and electrically connected to the plurality of second inner electrodes;
a first outer electrode on at least one of a first main surface and a second main surface of the capacitor body facing each other in a lamination direction of the plurality of dielectric layers, the plurality of first inner electrodes, and the plurality of second inner electrodes, and connected to the first via conductor;
a second outer electrode on the at least one of the first main surface and the second main surface of the capacitor body and connected to the second via conductor;
a first metal layer on a side surface of the capacitor body other than the first main surface and the second main surface, and electrically connected to the first via conductor; and
a second metal layer on the side surface of the capacitor body and electrically connected to the second via conductor.

9. The multilayer ceramic capacitor according to claim 8, further comprising:
a first connection layer inside the capacitor body to electrically connect the first via conductor and the first metal layer; and
a second connection layer inside the capacitor body to electrically connect the second via conductor and the second metal layer.

10. The multilayer ceramic capacitor according to claim 8, wherein the first metal layer and the second metal layer are each provided at a corner position across two side surfaces of the capacitor body.

11. The multilayer ceramic capacitor according to claim 8, wherein
the capacitor body includes four side surfaces;
one of the first metal layer and the second metal layer is provided at four corner positions across two side surfaces of the capacitor body; and
another of the first metal layer and the second metal layer is provided at a position between metal layers on each of the four side surfaces.

12. The multilayer ceramic capacitor according to claim 9, wherein
the first connection layer is provided in a layer in which one of the plurality of second inner electrodes is provided; and
the second connection layer is provided in a layer in which one of the plurality of first inner electrodes is provided.

13. The multilayer ceramic capacitor according to claim 9, wherein the first connection layer and the second connection layer are each provided in a layer in which one of the plurality of first inner electrodes is provided and in a layer in which one of the plurality of second inner electrodes is provided.

14. The multilayer ceramic capacitor according to claim 9, wherein
the first connection layer is provided in a layer in which one of the plurality of first inner electrodes is provided; and
the second connection layer is provided in a layer in which one of the plurality of second inner electrodes is provided.

15. The multilayer ceramic capacitor according to claim 13, wherein
the first connection layer is in contact with the first via conductor but not in contact with the first inner electrode; and
the second connection layer is in contact with the second via conductor but not in contact with the second inner electrode.

16. The multilayer ceramic capacitor according to claim 8, wherein
the first metal layer is a plated layer; and
the first outer electrode and the second outer electrode include plated electrodes.

17. The multilayer ceramic capacitor according to claim 8, wherein each of the plurality of dielectric layers includes BaTiO₃, CaTiO₃, SrTiO₃, SrZrO₃, or CaZrO₃ as a main component.

18. The multilayer ceramic capacitor according to claim 17, wherein each of the plurality of the dielectric layers includes a Mn compound, a Fe compound, a Cr compound, a Co compound, or a Ni compound as a subcomponent.

19. The multilayer ceramic capacitor according to claim 8, wherein each of the plurality of first and second inner electrodes includes Ni, Cu, Ag, Pd, Pt, Fe, Ti, Cr, Sn or Au, or and an alloy including Ni, Cu, Ag, Pd, Pt, Fe, Ti, Cr, Sn or Au.

20. The multilayer ceramic capacitor according to claim 8, wherein a thickness of each of the plurality of first and second inner electrodes is about 0.3 μm to about 1.0 μm.
